(19) United States
(12) Patent Application Publication
(10) Pub. No.: US 2010/0223552 A1
(43) Pub. Date: Sep. 2, 2010

(54) Playback Device For Generating Sound Events

(76) Inventor: Randall B. Metcalf, Cantonment, FL (US)

Correspondence Address: PILLSBURY WINTHROP SHAW PITTMAN, LLP, P.O. BOX 10500, MCLEAN, VA, 22102, US

(21) Appl. No.: 12/396,315

(22) Filed: Mar. 2, 2009

(51) Int. Cl. G06F 3/00

(52) U.S. Cl. 715/716

(57) ABSTRACT

A system configured to capture and/or produce a sound event generated by a plurality of sound sources. In particular, the system may be configured such that the capture, processing, and/or output for sound production of sound objects associated with separate ones of the sound sources may be controlled on an individual based. This discretized control over the sound objects may enhance various aspects of productions of the sound event by systems that do not capture, process and/or output sounds from different sound sources in a manner that maintains the discrete nature of the sound sources.

### RELATED APPLICATIONS

This application is related to U.S. Pat. No. 7,289,633, issued Oct. 30, 2007, U.S. Pat. No. 7,085,387, issued Aug. 1, 2006, U.S. patent application Ser. No. 11/048,783, filed Feb. 3, 2005, U.S. patent application Ser. No. 11/407,965, filed Apr. 21, 2006, U.S. Pat. No. 6,239,348, issued May 29, 2001, U.S. Pat. No. 6,444,892, issued Sep. 3, 2002, U.S. Pat. No. 6,740,805, issued May 25, 2004, U.S. Pat. No. 7,138,576, issued Nov. 21, 2006, U.S. patent application Ser. No. 11/131,275, filed May 18, 2005, U.S. patent application Ser. No. 11/592,141, filed Nov. 3, 2006, and U.S. patent application Ser. No. 11/260,171, filed Oct. 28, 2005, U.S. patent application Ser. No. 11/358,063, filed Feb. 22, 2006. All of these patents and applications are hereby incorporated by reference into this disclosure in their entirety.

### FIELD OF THE INVENTION

The invention relates to playback devices that obtain audio signals and drive sound rendering devices (e.g., amplifiers, speakers, etc.) to produce sound events from the obtained audio signals.

### BACKGROUND OF THE INVENTION

Generally, systems available for the capture, processing, and/or production of sound events (e.g., musical performances, movies, video games, etc.) work under a paradigm that includes four separate stages. These stages include a recording stage, a mixing/mastering stage, a distribution stage, and a playback stage.

At the recording stage, a sound event may include sounds produced separately by one or more sound sources. The separate sounds are transduced to audio signals and recorded to an electronically readable medium (e.g., hard drive, magnetic tape, optical disk, or other media). The audio signals may include analog and/or digital audio signals. The audio signals for the separate sources may be separately recorded.

At the mixing/mastering stage, the separate audio signals captured at the recording stage are mixed into “channels” according to a playback specification (e.g., stereo, 3.0, 4.0, 5.1, 6.1, 7.1, etc.), and the resulting mixed audio signals, one per channel, are re-recorded to an electronically readable medium. The separate channels typically correspond to a spatial separation of the original sound event (e.g., a left channel and a right channel).

Typically, the audio signals associated with each sound source producing sounds at the recording stage are reflected in some, if not all, of the mixed audio signals, and the relative levels of the audio signals associated with the different sound sources are varied between the mixed audio signals. The relative levels of the audio signals associated with the different sound sources on the different mixed audio signals may be controlled to create a set of virtual sound sources during playback corresponding to the sound sources that produced the event that was recorded in the recording stage, or to produce other effects.

The collection of mixed audio signals are then typically distributed as a whole by any known mechanism (e.g., on CD, DVD, digital file transfer such as MP3 or otherwise distributed). At the playback stage, the mixed audio signals recorded during the mixing/mastering stage are used to drive playback of the sound event through available rendering devices (e.g., loudspeaker/amplifier systems, headphones, and/or other rendering devices).

Generally, each mixed audio signal will be used to drive a single speaker or set of speakers separately from the rest of the speakers. The varying levels of the audio signals associated with the different sound sources present in the mixed audio signals cooperate during playback to create the set of virtual sound sources (sources that seem to be at locations other than the speaker positions), or the other effects intended when the mixed audio signals were created.

In some implementations, the recording stage and the mixing/mastering stage are performed by a common recording system/mastering system. In some implementations, the recording stage and the mixing/mastering stage are performed by separates systems. In some implementations the recording stage and the mixing/mastering stage are performed by a plurality of systems that perform at least part of one or both of the recording stage and the mixing/mastering stage. For example, recording studios and/or consumer computer hardware and/or software each provide capabilities for the recording stage and the mixing stage.

Generally, a playback device is implemented to control the playback stage. The playback device may control one or more rendering devices (e.g., speakers, amplifier, etc.) to generate sounds in accordance with the mixed audio signals corresponding to a sound event. Conventional playback devices enable some control over the sounds associated with one or more of the mixed audio signals to adjust, for example, the tone of the sounds as a group, the volume of the sounds as a group, and/or other controls over the group of sounds as a whole. However, once mixed, the audio signals associated with the different sound sources in each of the mixed audio signals cannot be separately controlled. Further, the authenticity of the sound event, the clarity of the sound event, and/or other aspects of the event may be diminished due to known effects produced by mixing audio signals representing sounds with different sonic characteristics.

Some systems may provide for audio signals recorded at the recording stage to be transduced and stored separately, even during the mixing/mastering stage. In such systems, the mixing/mastering stage may be somewhat less involved, as the creation of mixed audio signals may be reduced or eliminated. A playback device may be equipped to received the separate audio signals that correspond to the separate sound sources, and to drive a plurality of sound rendering devices to generate sounds from the separate sound sources separately (e.g., one audio signal per speaker or set of speakers). However, conventional playback devices may be limited with respect to the manner in which the separate audio signals are used to generate the sounds of the sound event.

### SUMMARY

One aspect of the invention relates to a system configured to capture and/or produce a sound event generated by a plurality of sound sources. In particular, the system may be configured such that the capture, processing, and/or output for sound production of sound objects associated with separate ones of the sound sources may be controlled on an individual basis. A sound object may include sound content corresponding to sounds generated by the corresponding sound source (e.g., an audio signal) and/or object metadata related to the corresponding sound source (or set of sound sources).

During the recording stage, a capture system may capture N separate sound objects, where the sound objects correspond to separate N sound sources (or discrete sets of sound sources). Object metadata included in a sound object may include information related to the corresponding to the sound source, other than sound content, that facilitates reproduction of sounds associated with the sound source during playback of the sound event. Some examples of object metadata may include one or more sonic characteristics of sounds generated by the sound source(s), a source type (e.g., a type of musical instrument, a brand and type of musical instrument, a type and style of musical instrument), information related to location, orientation, and/or movement during a sound event (relative to a reference point or other sound sources), a source identity (e.g., a name of a singer), an identity of a person (or persons) manipulating the sound source(s) (e.g., a name of a drummer playing a drum kit), an identity of a part being filled by the sound source(s) in a sound event (e.g., rhythm guitar, tenor vocalist), and/or other information.

The capture system may be configured to capture event metadata related to the sound event. As used herein, the term “event metadata” may refer to information, other than sound content, that pertains to the event as a whole, rather than to individual ones (or individual groups) of sound sources. For example, event metadata may include venue information related to the venue in which the sound event takes place. Venue information may include a venue identity, venue dimensions, venue surface characteristics (e.g., sound reflectivity of one or more surfaces of the venue), and/or other information related to the venue in which the sound event takes place. Other non-limiting examples of event metadata may include an event identity (e.g., a song title, a movie title), an event location, an event date, an event time, an event type, and/or other information related to the event as a whole.

During the playback stage, a playback device may obtain the sound objects separately, and may drive a set of sound rendering devices (e.g., amplifiers, speakers, headphones) to recreate sounds corresponding to the sound objects to reproduce the sound event. The playback device may obtain the sound objects from an electronically readable medium, such as an optically readable disk, a removable flash drive, a radio frequency signal, over a wired connection, and/or other electronically readable media. The separate sound objects may be received as separate audio signal(s) and a single information file that includes the object metadata for the individual sound objects, separate information files for the separate sound objects that include both sound content and object metadata for a given sound object, a single information file that includes the sound content and the object metadata for the separate sound objects (provided the sound content and object metadata for the separate sound objects can be accessed separately within the file), and/or otherwise obtained.

The playback device may include one or more of a production processor, a user interface, and/or other components. The production processor may process the sound objects to drive output of sounds associated with the sound objects by sound rendering devices in operative communication with the playback device. The user interface may enable a user to access information related to the production of the sound event and/or the sound objects associated with the sound event. As is discussed further below, the user interface may enable the user to control various aspects of the production of the sound event and/or the sound objects associated with the sound event.

The production processor may be configured to implement one or more computer program modules to perform the functions attributed herein to the playback device. The one or more modules may include one or more of a user interface module, an object module, a rendering device module, a path module, an assignment module, a group module, a venue module, a preferences module, and/or other modules.

The user interface module may enable a user to monitor and/or control operation of the playback device via the user interface in the manner described herein.

The object module may obtain the discrete sound objects associated with a given sound event, and may provide the separate audio signals obtained in the discrete sound objects for processing and/or output by the playback device. Obtaining a sound object may include obtaining sound content associated with the individual sound objects separately from each other and metadata associated with the sound objects. The object module may determine one or more sonic characteristics of sounds associated with individual ones of the sound objects based on the obtained sound content and/or metadata. During production of sounds associated with the sound objects, the object module may manipulate and/or process the individual audio signals associated with the discrete sound objects. This may enable one or more sonic characteristics of sounds associated with each of the individual sound objects to be controlled separately from the same one or more sonic characteristics of sounds associated with the other sound objects. The object module may control the sonic characteristics of sounds associated with individual ones of the sound objects based on input from the user via the user interface, based on metadata associated with the sound objects and/or the sound event as a whole, and/or based on other factors (some of which are discussed below).

The rendering device module may be configured to obtain device metadata related to individual ones of the sound rendering devices associated with the playback device. The device metadata obtained by the rendering device module may include information associated with the suitability of individual ones of the sound rendering devices for producing sounds associated with the sound objects obtained by the object module. For example, as used herein, the term “device metadata” may include properties of the sound rendering devices that enhance the production of sounds with certain sonic characteristics, information related to the position of the sound rendering devices, information related to a rotational orientation of the sound rendering devices, and/or other information.

Some or all of the device metadata may be obtained by the rendering device module through manual input to the playback device (e.g., via the user interface). Some or all of the device metadata may be obtained automatically by the rendering device module. For example, the rendering device module may be in operative communication with individual ones of the sound rendering devices, and may automatically communicate with the sound rendering devices to receive device metadata derived by, or stored on, the sound rendering devices. The rendering device module may be configured to determine at least some device metadata automatically. For instance, the rendering device module may be configured to automatically locate the sound rendering devices, and to automatically determine information related to the position of individual ones of the sound rendering devices.

The rendering device module may be configured to assign rending device metadata to individual rendering devices. For example, the rendering device module may assign a relative position to the rendering devices (e.g., left, right, middle, and/or other positions), sound object type (e.g., percussion, horns, string, etc.), and/or other rendering device metadata to individual rendering devices. The assignments may be based on characteristics of the rendering devices, input from a user (e.g., via the user interface), and/or other factors. In some implementations, the rendering device module may communicate with a docking station at which separate hardware modules comprising one or more rendering devices can be docked for charging. The rendering device module may assign rendering device metadata to the separate hardware modules based on the docks in the docking station that the rendering devices are docked into.

The sound rendering devices may be configured into M signal paths. Each signal path may to receive signals, and produce sounds from the received signals. The received signals may include audio signals provided by the object module from the obtained sound objects. The path module may be configured to determine the specific sound rendering devices to be included in each of the signal paths. The path module may further be configured to control each of the signal paths by selectively including and excluding individual sound rendering devices in the signal paths. In such embodiments, the path module may include or exclude a given sound rendering device in a signal path by powering the given sound rendering device on or off (or instructing the given sound rendering device to power on or off). The path module may be in operative communication with a series of switches and/or buses, and may include or exclude a given sound rendering device in a signal path by controlling the switches and/or buses to switch the given sound rendering device into or out of the signal path. The path module 36 may control the configuration of the signal paths automatically based on various parameters (e.g., the sonic characteristics of the sounds associated with the sound objects, the number of sound objects, the properties of sound rendering devices, and/or other properties) and/or based on user input to the playback device (e.g., via the user interface).

Each signal path may have one or more properties that enhance the production of sounds with certain sonic characteristics. For a given signal path, these properties (and/or the corresponding sonic characteristics) may be a result of the properties of the sound rendering devices included in the given signal path. The path module may obtain the one or more properties (or the corresponding sonic characteristics) of individual signal paths. For example, the path module may determine the one or more properties (or the corresponding sonic characteristics) of a given signal path based on an aggregation of the one or more properties of the sound rendering devices included in the given signal path.

According to various embodiments, the path module may configure a signal path for a specific one of the sound objects obtained by the object module. The signal path configured for the sound object may include sound rendering devices that enhance the production of sounds with one or more of the sonic characteristics of the sounds associated with the sound object (e.g., as determined by the object module, described above).

The assignment module may be configured to assign individual ones of the sound objects obtained by object module to the signal paths that include the sound rendering devices. The assignment module may then output the sound objects to the assigned signal paths for production of the sounds associated with the sound objects by directing the audio signals provided by the object module from the obtained sound objects to the appropriate signal paths. The assignment of a given sound object to one or more signal paths may be based on the sound content associated with the given sound object, the object metadata associated with the given sound object, and/or the device metadata associated with the sound rendering devices included in the assigned signal path. For example, the assignment module may assign the given sound object to a signal path that includes the sound rendering devices with one or more properties that enhance the production of sounds with one or more of the sonic characteristics of the sounds associated with the given sound object (e.g., as determined by the object module, described above).

The assignment module may assign sound objects to signal paths based on the relative locations of the sound objects (as indicated in the object metadata) and the relative locations of the sound rendering devices included in the signal paths. This may preserve the spatial arrangement of the sounds associated with the sound objects. The assignment of sound objects to signal paths based on the relative locations of the sound objects and the sound rendering devices may lead to the dynamic switching of assignments between sound objects and signal paths by the assignment module during production of the sound event associated with the sound objects, where object metadata indicates relative movement between sound objects during the sound event. In certain embodiments, this dynamic switching of assignments between sound objects and signal paths may be augmented (or even replaced) by dynamically switching the sound rendering devices into and/or out of signal paths by the path module to achieve apparent movement of the sound objects during the sound event.

One or more of the sound rendering devices may be configured to produce sounds associated with “virtual” sound objects, while one or more of the sound rendering devices may be configured to produce sounds associated with “physical” sound objects. As used herein, a “virtual” sound object may refer to a sound object that is produced by the sound rendering devices to be perceived by an observer as being emitted from a location different from the physical location of the sound rendering devices producing the sounds associated with the sound object. An example of this type of sound object would be a sound object reproduced via a surround-sound system (e.g., a 5.1 system, a 6.1 system, etc.). As used herein, a “physical” sound object may refer to a sound object that is produced by one or more sound rendering devices such that the sound rendering devices are located at the position perceived by an observer to be the source of the sound.

In some instances, the assignment module may assign individual sound objects to certain signal paths based on whether they should be output as virtual sound objects or physical sound objects, and whether a given signal path is configured to produce sounds associated with sound objects virtually or physically. For example, object metadata of the sound objects may indicate explicitly whether a given sound object is to be output virtually or physically. As another non-limiting example, the object module may determine which sound objects are to be output virtually or physically based on one or more of object metadata (e.g., one or more sonic characteristics, position, movement, etc.), resources available to the playback device (e.g., the number of sound rendering devices capable of producing physical sound objects, processing resources, etc.), and/or other information.

The group module may form one or more groups of sound objects, with each group of sound objects including two or more of the sound objects obtained by the object module. Sound objects that are included within a common group may be controlled in a coordinated manner by the group module. For example, the group module may control one or more of the sonic characteristics of sound associated with the sound objects included within a given group of sound objects in a coordinated manner separate from the same sonic characteristics of sounds associated with sound objects not included in the given group. This may include simultaneously adjusting a sonic characteristic of the sounds associated with the sound objects included within the given group of sound objects without substantially impacting the same sonic characteristics of sounds associated with sound objects not included in the given group of sound objects.

To control sound objects that are included within a common group, the group module may assign these sound objects to a common signal path, or set of signal paths, by the path module. This should not be misunderstood to mean that the audio signals associated with grouped sound objects are necessarily processed together within the playback device as a “mixed” signal that includes all of the audio signals associated with sound objects within the group inseparably from each other. The audio signals associated with the grouped sound objects may be output over one or more common signal paths and/or may be controlled in a coordinated manner. However, discrete control over the audio signal(s) associated with individual sound objects is still maintained such that the audio signal(s) associated with a given one of the grouped sound objects may still be controlled separately from the audio signals associated with the other sound objects in the group by the object module (e.g., to modify one or more of the sonic characteristics of the given object separately from the other sound objects in the group). Further, audio signals from individual sound objects within the group, even after inclusion in the group, may still be removed from the other audio signals associated with the group by the group module to be processed and/or separately from the group.

The group module may group the sound objects based on sound content and/or metadata associated with the sound objects. For example, the group module may group the sound objects such that sound objects with relatively diffuse directivity patterns (which may lend themselves to output as virtual sound objects) are formed into a group, while sound objects with relatively well defined directivity patterns (which may be relatively less suited to output as virtual sound objects) may be excluded from the group. This may enable the audio signals associated with grouped sound objects to be output to one or more signal paths that include sound productions devices that produce directionally diffuse sounds, while the audio signals associated with sound objects having well defined directivity patterns may be output to one or more signal paths that include sound productions devices that can mimic their directivity patterns. As another example, the group module may group audio signals associated with sounds that are more peripheral to a sound event together so that the reproduction of these sounds will not subsume sound production resources (e.g., sound rendering devices, processing resources on the production processor, and/or other resources) that are out of balance with their subjective import to the sound event. For instance, where some sound objects represent one or more ambient sound sources (e.g., traffic noise, dog barks, background conversations, etc.) and/or one or more ancillary sound sources (e.g., a set of backup vocalists, a rhythm section, etc.), these sound objects may be grouped by the group module for processing together in a coordinated manner, as described above.

The grouping of sound objects by the group module may be performed in an automated manner. The grouping may be performed (and/or manipulated) by the group module based on user input to the playback device (e.g., received via user interface 28). In some instances, the manner in which the group module should group obtained sound objects (at least initially) may be specified explicitly by object metadata and/or event metadata. As was mentioned above, such metadata may be included in the sound objects and/or with the sound objects by the capture system and/or a mastering system.

Where the group module has formed a group of two or more sound objects, and the audio signals associated with the grouped sound objects are to be output over a common signal path, or set of signal paths, the assignment module may assign the grouped sound objects to a common signal path, or set of signal paths, based on one or both of the sound content and/or the metadata associated with the individual sound objects in the group of sound objects. The assignment of the grouped sound objects to the common signal path, or set of signal paths, may further be based on one or more of the properties of the sound rendering devices included in the common signal path, or set of signal paths.

The venue module may be configured to determine information related to a venue in which a sound event is being produced by the playback device. This information may include one or more of venue dimensions, venue surface characteristics (e.g., sound reflectivity of one or more surfaces of the venue), and/or other information related to the venue in which the sound event is being produced. The venue module may compare this information with information related to the venue in which the sound objects were captured by capture the system (e.g., included in the event metadata). From this comparison, the venue module may determine adjustments to the sound objects (e.g., adjustments to the audio signals from the sound objects) to account for acoustical differences between the venue in which the sound objects were captured and the venue in which the sound event is being produced by the playback device. These adjustments may be communicated from the venue module to the object module for implementation.

The preferences module may manage preferences associated with the playback device. The preferences managed by preference managed by the preference module may include preferences associated with an individual user, a group of users, or the “preferences” may refer to settings configured for any use of the playback device (e.g., configured by a technician installing some or all of the components of the playback device). The preferences may dictate the manner in which other modules provided within the playback device process and/or output obtained sound objects. In some instances, the preferences may dictate defaults for processing and/or output that can be further adjusted by a user (e.g., via the user interface).

In some embodiments, the preference module may store a set of templates for signal paths that can be configured by the path module by selectively including or excluding sound rendering devices within a signal path. A given template may be selected by a user (e.g., via the user interface) to initiate configuration of the signal path that corresponds to the given template. These templates may include templates that are pre-programmed to the production processor, downloaded from an external source (e.g., the Internet, a removable storage media, and/or other sources.), obtained with the sound objects associated with a given sound event, or obtained from some other source. In some instances, the templates may be adjusted by a user, or even created completely by the user. The templates may enable a user to quickly configure a “custom” signal path without having to manually select individual sound rendering devices for inclusion or exclusion in the signal path.

According to various embodiments, the preference module may automatically track user interaction with the path module, and may suggest preferences to the user. For example, the preference module may track the signal paths configured by the user over time, and may identify a signal path configuration that is repeatedly created by the user. The preference module may then present this signal path configuration to the user with the suggestion that the configuration be saved as a template. Upon approval from the user, the preference module may then save the signal path configuration as a template. As another non-limiting example, the preference module may identify a modification that the user repeatedly makes to the configuration of a signal path that corresponds to a given template. The preference module may present an option to the user to modify the given template in accordance with the modification, which may relieve the user from having to make this modification in the future. Similarly, the preference module may present an option to the user to create a new template that corresponds to the given template with the exception of the modification that is frequently made by the user. This may relieve the user of having to make the modification in the future, while still enabling the user to access the given template in its unaltered form.

With respect to the assignment module, the preference module may manage one or more preferences related to the manner in which sound objects are assigned to signal paths. This may include preferences that dictate that sound objects with certain properties are assigned to predetermined signal paths, or predetermined types of signal paths. The properties of a sound object may include one or more sonic characteristics of the sound object, one or more sonic characteristics of the sounds associated with a sound object, one or more properties of sound content associated with the sound object, a position of the sound object, a rotational orientation of the sound object, movement of the sound object, an object type of the sound object (e.g., a type of musical instrument, a brand and type of musical instrument, a type and style of musical instrument, etc.), an object identity of the sound object (e.g., a name of a singer), an identity of a person involved in the production of sounds associated with the sound object (e.g., a name of a drummer playing a drum kit), an identity of a part being filled by the sound object in a sound event (e.g., rhythm guitar, tenor vocalist, etc.), and/or other properties. In some instances, the preferences managed by the preference module with respect to the assignment of sound objects to signal paths may define and/or influence default assignments of sound objects to signal paths that can then be adjusted by a user (e.g., via the user interface).

In some instances, the preferences managed by the preference module may be based on more than one parameter. For example, a given preference may dictate and/or influence assignment of a sound object to one or more signal paths based on a plurality of properties of the sound object. In some instances, a given preference may dictate and/or influence assignment of a set of sound objects to a set of signal paths based on one or more properties of each of the individual sound objects included in the set of sound objects. For instance, a given preference may dictate that for a sound event that includes sound objects corresponding to a traditional jazz trio (e.g. drums, bass, and soloist), the sound objects are to be assigned to their role within the trio. In other words, where the sound objects designate a drum kit, a bass, and a soloing instrument (e.g., saxophone, clarinet, piano, guitar, etc.), a preference managed by preference module 44 may dictate and/or influence the assignment of these sound objects to signal paths designated in the preference for the rhythm objects (e.g., the drum kit and bass) and the soloing instrument. In some implementations, the preference may further require that event metadata associated with the sound objects indicate that this is a jazz trio, and not some other type of performance (e.g., rock band), or a part of an event that includes additional sound objects (e.g., the trio backs a vocalist).

According to various embodiments, one or more of the preferences managed by the preference module may be conceptualized as templates that assign sound objects with certain properties to signal paths that include sound rendering devices 14 with certain properties. In some instances, a template may correspond to an event type. For example, an event type may include a concert, a movie, a television show, a sporting event, a video game, and/or other event types. Event types, in some implementations, may be even more specific. For example, an event type may include a rock concert, a jazz concert, a symphony concert, an opera, an action movie, a romantic movie, a comedic television show, a reality television show, a basketball game, a bull fight, a world cup soccer match, a Halo 3 game, a Grand Theft Auto game, and/or other event types. An event type of a sound event may be determined by the preference module based on the sound objects associated with the sound event, based on event metadata captured by the capture system (and/or included with the sound objects at a mastering system), based on user input to the playback device (e.g., via the user interface) and/or based on other information related to the sound event.

A preference that corresponds to a given event type may dictate and/or influence the assignment of sound objects generally associated with the given event type to signal paths with configurations of the sound rendering devices that lend themselves to the production of sounds associated with sound generally associated with the given event type. For examples if the given event type is a popular music concert, the preference may dictate and/or influence the assignment of a sound object associated with a lead performer (e.g., a lead singer) to a signal path with one or more sound rendering devices that have one or more properties that enhance production of sounds generally associated with a lead performer. For example, such a signal path may include one or more sound rendering devices located at a centralized position, one or more sound rendering devices with acoustic properties that enhance production of sounds generally associated with a lead performer, and/or other sound rendering devices. Similarly, the same preference may dictate and/or influence the assignment of individual ones of the other sound objects associated with the concert to signal paths that have one or more properties that enhance production of the sounds generally associated with other individual sound objects typically included in such a concert (e.g., typical instruments, backup vocalists, crowd noises, etc.).

A preference managed by the preference module may be event and/or sound object specific. For example, the preference may include a template for assigning the sound objects associated with a given event to signal paths. The preference may be specifically designed for the specific event. Such a preference may be included, for example, in event metadata associated with the sound event, or may be previously stored at the playback device. In some instances, such a preference may be created by the user (e.g., via the user interface). For example, the preference may be based on a previous assignment of the sound objects associated with the given sound event to signal paths that is specified by the user to be saved as a preference for production of the given sound event in the future.

In some embodiments, the preference module may present the user (e.g., via the user interface) with a plurality of preferences (e.g., a plurality of templates) for dictating and/or influencing the assignment of sound objects to signal paths for a sound event to enable the user to select a preference to be applied to the sound event. In some such embodiments, preference module 44 may preliminarily apply one of the preferences (e.g., based on previous use, etc.), and may request approval from the user. If the user does not approve, then the user may select an alternative preference to be applied from the plurality of preferences.

According to various embodiments, the preference module may manage the preferences related to the assignment module such that existing preferences may be adjusted and/or new preferences may be created automatically by tracking adjustments made to assignments of sound objects to signal paths by the user. As a non-limiting example of this functionality, the preference module may observe that the user routinely assigns sound objects of a certain type to a particular signal path. Based on this observation, the preference module may create a preference that dictates that sound objects of the certain type be assigned by assignment module to the particular signal path. In some instances, the preference module may request authorization from the user before creating the preference.

With respect to the group module, the preference module may manage preferences related to the grouping of sound objects by the groups module. This may include preferences that dictate that sound objects with one or more similar properties are grouped together. Such preferences may specify the one or more properties upon which the grouping should be base, the correlation required between the specified one or more properties to warrant grouping, and/or other aspects of the grouping of sound objects. The properties of a sound object may include one or more sonic characteristics of the sound object, one or more sonic characteristics of the sounds associated with a sound object, one or more properties of sound content associated with the sound object, a position of the sound object, a rotational orientation of the sound object, movement of the sound object, an object type of the sound object (e.g., a type of musical instrument, a brand and type of musical instrument, a type and style of musical instrument, etc.), an object identity of the sound object (e.g., a name of a singer), an identity of a person involved in the production of sounds associated with the sound object (e.g., a name of a drummer playing a drum kit), an identity of a part being filled by the sound object in a sound event (e.g., rhythm guitar, tenor vocalist, etc.), and/or other properties.

Another aspect of the invention may relate to a sound rendering device. The sound rendering device may include one or more speakers, amplifiers, headphones, and/or other devices. The sound rendering device may include one or more of a sound signal processing module, a metadata module, a control communication module, a metadata module, a feedback control module, and/or other modules.

The sound signal processing module may process signals to facilitate the production of sounds based on the signals. For example, in instances in which the sound rendering device includes an amplifier, the sound signal processing module may, among other things, amplify an audio signal. As another non-limiting example, in instances in which the sound rendering device includes a speaker, the sound signal processing module may, among other things, produce a sound wave from a received audio signal.

The metadata module may store and/or manage device metadata associated with the sound rendering device. The device metadata may include information related to the sound rendering device such as, for example, information associated with the suitability of the sound rendering device for producing sounds with various sonic characteristics. For example, such information may include properties of the sound rendering device that enhance the production of sounds with certain sonic characteristics, information related to the position of the sound rendering device, information related to a rotational orientation of the sound rendering device, a brand name of the sound rendering device, a model name and/or number of the sound rendering device, and/or other information. In some instances, the device metadata may include information provided to the metadata module at or near the time of manufacture of the sound rendering device, information provided to the metadata module at or near the time of installation of the sound rendering device in a venue as a component in the playback device, and/or at other times. In certain embodiments, at least some of the device metadata stored and/or managed by the metadata module may be entered and/or adjusted by a user. In some embodiments, at least some of the device metadata stored and/or managed by the metadata module may be provided to the metadata module by a manufacturer and/or technician. Some or all of the device metadata provided to the metadata module by a manufacturer and/or technician may be stored and/or managed by the metadata module such that it cannot be adjusted by a user.

The interface module may be configured to manage communication of information between a user and the sound rendering device module. Such communication may include the communication of device metadata to a user and/or the communication of device metadata (and/or adjustments to be made to the device metadata) to the sound rendering device. In some embodiments, the interface module may manage communication between the user and the sound rendering device accomplished via a user interface. This user interface may include a user interface located locally on the sound rendering device, or a user interface located remotely from the sound rendering device (e.g., the user interface).

The control communication module may manage communication between the sound rendering device and one or more other components of the playback device. For example, the control communication module may receive information from and/or transmit information to the production processor. The information communicated by the control communication module may include the communication of device metadata from the sound rendering device to the production processor (e.g., to the rendering device module). This communication may enable the production processor to make determinations with respect to which sound objects will be assigned to signal paths that include the sound rendering device.

The feedback control module may be configured to capture and/or process feedback information that can be provided to one or more other components of the playback device (e.g., the production processor) to enhance the production of sounds by the sound rendering device. In some embodiments, the feedback information may include sound information actually being produced by the sound rendering device (e.g., recorded by a transducer on the sound rendering device). The sound information may then be provided to the production processor via the feedback control module to enable the production processor to compare sound actually being produced by the sound rendering device with the sound intended for the sound rendering device, and to adjust control of the sound rendering device in a feedback manner. The feedback control module may implement some or all of the feedback functionality locally at the sound reproduction device, thereby reducing processing load on the production processor 26. For example, the feedback control module may process the sound produced by the sound rendering device and may analyze the sound to ensure accuracy with respect to sounds that should be produced, adjust performance of the sound rendering device on a feedback basis, diagnose maintenance and/or other system hardware issues, and/or provide other functionality based on the captured sound information.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to capture and/or reproduce a sound event, according to one or more embodiments of the invention.

FIG. 2 illustrates a sound rendering device, in accordance with one or more embodiments of the invention.

FIG. 3 illustrates a system configured to reproduce a sound event, according to one or more embodiments of the invention.

FIG. 4 illustrates a user interface, in accordance with one or more embodiments of the invention.

### DETAILED DESCRIPTION

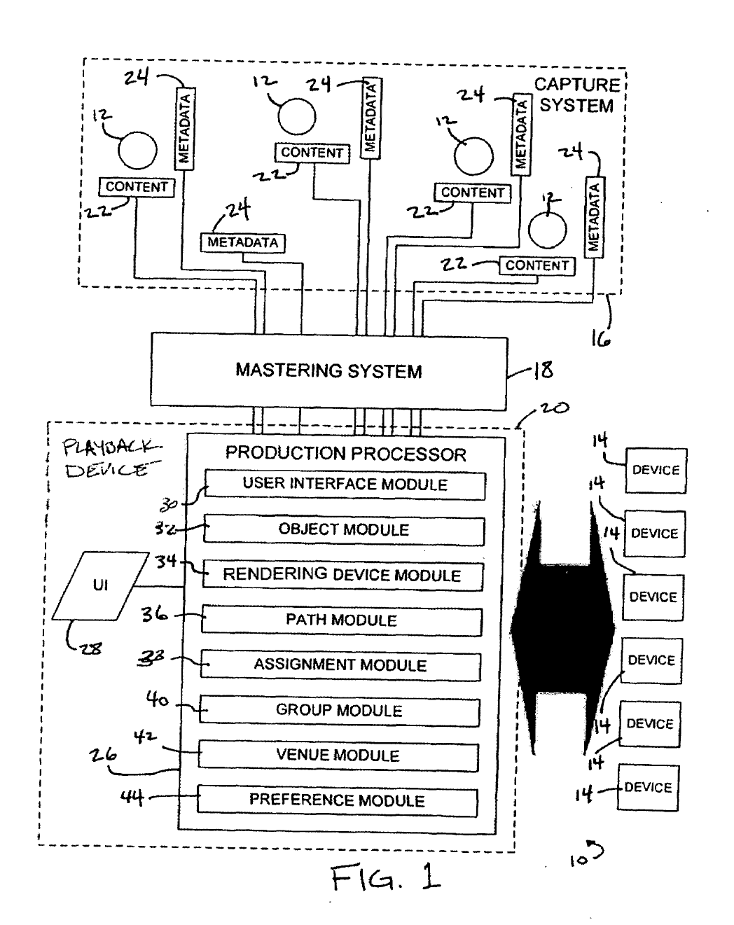

FIG. 1 illustrates a system 10 configured to capture and/or produce a sound event generated by a plurality of sound sources 12, according to one or more embodiments of the invention. System 10 may capture and process signals corresponding to sounds generated by separate ones of sound sources 12 during a sound event in a discretized and/or separate manner so as to enhance production of the sound event by a plurality of sound rendering devices 14. The production of the sound event by sound rendering devices 14 may be enhanced in reality, customization, clarity, configurability, and/or otherwise enhanced. In some embodiments, system 10 may include a capture system 16, a mastering system 18, a playback device 20, and/or other components.

As used herein, the term “sound source” may denote any object or set of objects that produce sound. For example, in some instances, a single musical instrument may form a sound source. In some instances, a plurality of instruments may form a single sound source (e.g., a brass section of a band, a violin section of an orchestra, etc.). In some instances, a component part of a musical instrument may be viewed as a sound source separate from other components of the same musical instrument (e.g., the separate strings of a guitar, etc.).

Sound rendering devices 14 may include any device, or group of devices, that process signals for the production of sound based on the signals. Some non-limiting examples of sound rendering devices 14 include an amplifier, a speaker, a transducer, and/or other devices that process signals for the production of sound. In some instances, a sound rendering device 14 may actually include a set of devices. For example, a sound rendering device 14 may include a plurality of amplifier elements, a plurality of speaker elements, or one or more amplifier elements and one or more speaker elements.

Each sound rendering device 14 may have one or more properties that enhance the production of sounds with certain sonic characteristics. For example, where a given sound rendering device 14 includes an amplifier, the one or more properties of the given sound rendering device 14 that enhance the production of sounds with certain sonic characteristics may include one or more of a gain, an output dynamic range, a bandwidth and rise time, a settling time, a slew rate, noise, an efficiency, a linearity, and/or other properties. As another example, where a given sound rendering device includes a speaker, the one or more properties of the given sound rendering device 14 that enhance the production of sounds with certain sonic characteristics may include one or more of a power, an impedance, a frequency response, a sensitivity, a maximum SPL, a distortion, a directivity, a directivity pattern, and/or other properties.

Capture system 16 may capture information related to a sound event. The information captured by capture system 16 may include the capture of N “sound objects” associated with individual sound sources 12 (or separate groups of sound sources) that generate sounds during a sound event. A sound object corresponding to a given sound source 12 may include sound content generated by the given sound source 12 during the sound event, object metadata related to the given sound source 12 during the event, and/or other information related to sounds generated by the given sound source 12 during the event. At least some of the information captured as part of a sound object associated with the given sound source 12 during the sound event may be captured and maintained by capture system 16 separate from information captured as part of sound objects associated with other ones of the sound sources 12. In some embodiments, capture system 16 may include a set of content capture modules 22, one or more metadata capture modules 24, and/or other components.

Content capture modules 22 may include one or more microphones, piezoelectric transducers, and/or other sensors that generate signals (e.g., electrical signals) in response to the reception of sound waves generated by a sound source 12. The signals generated by a given content capture module 22 may convey the content of sounds generated by one or more sound sources 12 adjacent to content capture module 22. As used herein, the term “sound content” may refer to the actual sounds generated by a sound source 12 (or set of sound sources), and conveyed by the signals generated by at least one of the content capture modules 22 during a sound event. In order to capture the sound content generated by sound sources 12 separately, each of sound sources 12 may have one or more content capture modules 22 that are arranged to capture only (or substantially only) the sound content associated with a single sound source 12. The signals generated by the one or more content capture modules 22 arranged to capture only the sound content of a given sound source 12 may then be stored, transmitted, mastered, played back, and/or otherwise processed discretely from the sound content associated with other ones of sound sources 12. As was mentioned above, this discretization of the sound content associated with separate ones of sound sources 12 may enable one or more enhancements in the production of sound events by system 10.

In some instances, a content capture module 22 assigned to an individual sound source 12 to separately capture the sound content associated with a given sound source 22 may include a single device (e.g., a single microphone). In some instances, content capture module 22 may include a plurality of devices implemented to capture sound content associated with a single sound source 12 (or set of sound sources). For example, the plurality of devices included in content capture module 22 may be arranged on a surface surrounding sound source 12 to capture the sound content associated with sound source 12 along the surface. This may enable the signals generated by the plurality of content capture modules 22 to convey information related to sound source 12 other than just sound content. For instance, the signals generated by the plurality of content capture modules may further convey a directionality of the sounds generated by sound source 12, a directivity pattern of sound source 12, and/or other information. This capture of information other than simple sound content by content capture module 22 may enable content capture module 22 to function as a metadata capture module 24 (the operation of which is discussed further below), as well as a content capture module 22. Some embodiments including a plurality of devices in a content capture module 22 being implemented to capture sound content and/or other information from a single sound source 12 (or set of sound sources) are described in the related patents and/or applications set forth above.

Metadata capture modules 24 may include one or more modules that capture object metadata included in sound objects associated with sound sources 12 during the generation of a sound event by sound sources 12. As used herein, the term “object metadata” may refer to information related to sound sources other than sound content that facilitates production of a sound event generated by sound sources 12. For example, as was mentioned above, object metadata may include a directionality of sounds generated by a given sound source 12 and/or a directivity pattern of the given sound source 12. Other non-limiting examples of object metadata may include information related to the position of the given sound source 12, information related to a rotational orientation of the given sound source 12, a source type of the given sound source 12 (e.g., a type of musical instrument, a brand and type of musical instrument, a type and style of musical instrument, etc.), information related to movement of the given sound source 12 during a sound event, an identity of the given sound source 12 (e.g., a name of a singer), an identity of a person manipulating the given sound source 12 (e.g., a name of a drummer playing a drum kit), an identity of a part being filled by the given sound source 12 in a sound event (e.g., rhythm guitar, tenor vocalist, etc.), and/or other information.

In some embodiments, metadata capture modules 24 may include an interface that enables a person to manually enter object metadata. In some embodiment, metadata capture modules 24 may include one or more sensors that automatically detect object metadata. For example, metadata capture modules 24 may include one or more sensors that detect a directionality of sounds emitted by a sound source 12 (e.g., as discussed above), a directivity pattern of a sound source 12 (e.g., as discussed above), a position of a sound source 12, movement of a sound source 12, and/or other information. In some instances, metadata capture modules 24 may be in electronic communication with one or more of sound sources 12 (e.g., wired communication, wireless communication, networked communication, communication via dedicated lines, etc.), and may automatically receive object metadata associated with individual sound objects from the sound sources 12 themselves.

According to various embodiments of the invention, metadata capture modules 24 may obtain event metadata. As used herein, the term “event metadata” may refer to information, other than sound content, that pertains to the event as a whole, rather than to individual ones (or individual groups) of sound sources 12. For example, event metadata may include venue information related to the venue in which the sound event takes place. Venue information may include a venue identity, venue dimensions, venue surface characteristics (e.g., sound reflectivity of one or more surfaces of the venue), and/or other information related to the venue in which the sound event takes place. Other non-limiting examples of event metadata may include an event identity (e.g., a song title, a movie title, etc.), an event location, an event date, an event time, an event type, and/or other information related to the event as a whole.

In some embodiments, capture system 16 may electronically store sound content, object metadata, and/or event metadata captured by content capture modules 22 and/or metadata capture modules 24. Sound content may be stored in the form of audio signals that correspond to the sounds produced by sound sources 12. In such embodiments, sound content associated with individual ones of the sound objects that correspond to sound sources 12 may be stored separately for each of the sound objects (e.g., the audio signals are stored separately without mixing). Similarly, object metadata associated with separate sound objects may be stored separately. However, sound content associated with a given sound object may be correlated in storage with object metadata associated with the given sound object, so that both the sound content and the object metadata associated with the given sound object may be accessed together as a single sound object.

In some implementations, the sound content, object metadata, event metadata and/or other information captured by capture system 16 may be electronically stored to a removable electronic storage medium (e.g., optically readable disc, magnetic tape, optically readable tape, solid state memory, etc.). In some implementations, the sound content, object metadata, event metadata, and/or other information captured by capture system 16 may be electronically stored to an electronic medium in electronic communication with one or both of mastering system 18 and playback device 20 for transmission to system 18 and/or system 20. In some implementations, the sound content, object metadata, event metadata, and/or other information captured by capture system 16 is not saved at capture system 16, but instead is transmitted directly to one or both of mastering system 18 and playback device 20.

Mastering system 18 may enable the sound objects (e.g., the captured sound content, metadata, etc. associated with sound sources 12) associated with a sound event that are captured by capture system 16 to be mastered. This may include processing the sound content and/or metadata in preparation for the sound event to be produced by playback device 20 from the captured sound objects. As should be appreciated from the following description, at least some of the processing discussed with respect to mastering system 18 may be performed by playback device 20, and vice versa. However, mastering system 18 may enable the sound objects to be processed prior to production of the sound event associated with the sound objects (e.g., by a mixing engineer, by a user prior to playback, etc.).

In some embodiments, mastering system 18 may enable the sound objects to be individually adjusted. These adjustments may be made for a variety of reasons, including, for example, to conform the sound objects to the desires of an artist (or producer, etc.) involved in the generation of the sound event, to make the sound objects conform more closely with the original sound sources 12, to facilitate production of the sound event based on the sound objects, and/or for other reasons. The adjustments made by mastering system 18 may be made in response to input from an operator of mastering system 18. For example, in a traditional commercial music paradigm, the operator may include an artist, a producer, a mixing engineer, and/or other individuals affiliated with the artist and/or the production company formatting a musical sound event for consumer consumption.

The adjustments made to the sound objects by mastering system 18 may include adjustments to the sounds associated with the captured sound objects. For example, mastering system 18 may adjust one or more sonic characteristics of the sound content associated with individual sound objects. This may include adjusting the tone, volume level, directivity, timbre, and/or other sonic characteristics of the sound content associated with a sound object. Such adjustment of the sonic characteristics of sound content may be made in a coordinated manner to the sound content associated with a set of sound objects, or to the sound content associated with a single sound object separate from the other sound objects. Adjustments to the sound content associated with the sound objects may be made to enhance the authenticity of the sound objects, or to purposefully alter the sound content associated with the sound objects from the sounds output by sound sources 12 during the sound event.

The adjustments made to the sound objects by mastering system 18 may include adjustments to a timing relationship among the sound objects that dictates the timing of the production of the sound content associated with the various sound objects. For example, mastering system 18 may delay the timing of the production of sound content associated with one sound object with respect to the production of sound content associated with other sound objects, mastering system 18 may reduce (or increase) a speed at which the sound content associated with a specified sound object is produced, and/or the timing of the production of the sound content associated with the sound objects may otherwise be adjusted by mastering system 18.

In some instances, the adjustments made to the sound objects by mastering system 18 may include adjustments to metadata associated with the sound event and/or the sound objects. These adjustments may include associating new metadata with the event and/or sound objects (e.g., new event metadata identifying the event, the venue, etc., new object metadata identifying the sound source(s) associated with the sound object, etc.) and/or altering existing metadata. For example, mastering system 18 may adjust object metadata associated with a given sound object to adjust one or more of the sonic characteristics of the sound object (e.g., a directionality, a directivity pattern), information related to the position of the sound object during the sound event (e.g., position, motion, rotational orientation, etc. of the sound object during the sound event), and/or other information included in the object metadata.

In some instances, mastering system 18 may associate previously stored metadata with one or more of the sound objects. For example, mastering system 18 may store object metadata describing one or more sonic characteristics (e.g., directivity pattern, etc.) of specific object types (e.g., for different instrument types). Mastering system 18 may associate stored object metadata describing one or more sonic characteristics of individual sound objects (and/or other parameters of sound objects) based on a specification of object type already included with the sound objects. Alternatively, mastering system 18 may specify (or alter a previous specification of) an object type for a given sound object, as well as associate the corresponding object metadata with the given sound object describing one or more sonic characteristics of the given sound object. The object metadata stored by mastering system 18 that corresponds to specific object types may be obtained by mastering system 18 from a user (via manual input), downloaded from an external source, via encoding at manufacture, and/or from other sources.

According to various embodiments, the sound objects associated with the sound event may be grouped into one or more groups of two or more sound objects. A group of sound objects may then be processed for production in a coordinated manner (as is discussed further below). In some instances, the metadata associated with the sound event and/or the sound objects may dictate the manner in which the sound objects are grouped into the one or more groups. In these instances, mastering system 18 may enable these groups to be selectively specified in the metadata.

Due to the customizable nature of the production of sound events by system 10, at least some of the same adjustments that may be made to sound content and/or metadata by mastering system 18 may also be made by a user via production processor 20 (as should be appreciated from the description of playback device 20 below). As a result, at least some of the adjustment to sound content and/or metadata associated with a sound event and/or sound objects included in the sound event by mastering system 18 may comprise merely defaults for the production of the sound event by playback device 20. Further, in some implementations, mastering system 18 may be included wholly within playback device 20, or may not even be included at all in system 10.

Playback device 20 may be configured to drive a plurality of sound rendering devices 14 to reproduce a sound event associated with a set of sound objects. Playback device 20 may include one or more of a production processor 26, a user interface 28, and/or other components. Production processor 26 may process the sound objects to drive output of sounds associated with the sound objects by sound rendering devices 14. User interface 28 may enable a user to access information related to the production of the sound event and/or the sound objects associated with the sound event. User interface 28 may enable the user to control various aspects of the production of the sound event and/or the sound objects associated with the sound event.

User interface 28 is configured to provide an interface between playback device 20 and a user through which the user may provide information to and receive information from playback device 20. This may enable production data, results, and/or instructions and any other communicable items, collectively referred to as “information,” to be communicated between the user and playback device 20. Examples of interface devices suitable for inclusion in user interface 28 include a keypad, buttons, switches, a keyboard, knobs, levers, a display screen, a touch screen, speakers, a microphone, an indicator light, an audible alarm, and a printer. It may be appreciated that other communication techniques, either hard-wired or wireless, are also contemplated by the present invention as user interface 28. For example, the present invention contemplates that user interface 28 may be integrated with a removable storage interface. In this example, information may be loaded into system 20 from removable storage (e.g., a smart card, a flash drive, a removable disk, etc.) that enables the user(s) to customize the implementation of system 20. Other exemplary input devices and techniques adapted for use with system 20 as user interface 28 include, but are not limited to, a data port (e.g., RS-232, USB, firewire, etc.), RF link, an IR link, modem (telephone, cable or other). In short, any technique for communicating information with system 20 is contemplated by the present invention as user interface 28.

Production processor 26 may include one or more of a digital processor, an analog processor, a digital circuit designed to process information, an analog circuit designed to process information, a state machine, and/or other mechanisms for electronically processing information. Although production processor 26 is shown in FIG. 1 as a single entity, this is for illustrative purposes only. In some implementations, production processor 26 may include a plurality of processing units. These processing units may be physically located within the same device, or production processor 26 may represent processing functionality of a plurality of devices operating in coordination.

As is illustrated in FIG. 1, in some embodiments, production processor 16 may include one or more of a user interface module 30, an object module 32, a rendering device module 34, a path module 36, an assignment module 38, a group module 40, a venue module 42, a preferences module 44, and/or other modules. Modules of production processor 26 (e.g., modules 30, 32, 34, 36, 38, 40, 42, and 44) may be implemented in software; hardware; firmware; some combination of software, hardware, and/or firmware; and/or otherwise implemented. It should be appreciated that although modules 30, 32, 34, 36, 38, 40, 42, and 44 are illustrated in FIG. 1 as being co-located within a single processing unit, in implementations in which production processor 26 includes multiple processing units, one or more of modules 30, 32, 34, 36, 38, 40, 42, and/or 44 may be located remotely from the other modules.

User interface module 30 may manage the communication of information between production processor 26 and a user via user interface 28. This may include formatting information for conveyance to the user via user interface 28 (e.g., by generating displays to be conveyed to the user via user interface 28) and/or receiving information input by the user to playback device 20 via user interface 28.

Object module 32 may obtain discrete sound objects associated with a given sound event. Obtaining a sound object may include obtaining the audio signals associated with the individual sound objects separately from each other and metadata associated with the sound objects. The metadata may include one or both of object metadata that pertains to individual sound objects and/or event metadata that pertains to the sound event as a whole. In some embodiments, object module 32 may obtain the sound objects from an electronically readable medium on which the sound objects are stored (e.g., by capture system 16 and/or mastering system 18). In some embodiments, object module 32 may obtain the sound objects via transmission from another system (e.g., from capture system 16 and/or mastering system 18).

According to various embodiments, object module 32 may generate signals for transmission to sound rendering devices 14 that enable sound rendering devices 14 to reproduce sounds associated with the obtained sound objects. Since the sound objects are obtained by object module 32 separately from each other, the audio signals from the sound objects may be provided to sound rendering devices 14 separately for individual sound objects.

In some instances, object module 32 may associate previously stored object metadata with one or more of the sound objects. For example, object module 32 may store object metadata describing one or more sonic characteristics (e.g., directivity pattern, etc.) of specific object types (e.g., for different instrument types). Object module 32 may associate stored object metadata describing one or more sonic characteristics of individual sound objects (and/or other parameters of sound objects) based on a specification of object type already included with the sound objects. The object metadata stored by object module 32 that corresponds to specific object types may be obtained by object module 32 from a user (via manual input), downloaded from an external source, via encoding at manufacture, and/or from other sources. In some implementations, this object metadata may be customizable based on user preferences.

In some embodiments, object module 32 may determine one or more sonic characteristics of sounds associated with individual ones of the sound objects based on the obtained audio signals and metadata. For example, from the audio signals and object metadata associated with a given sound object, object module 32 may determine one or more sonic characteristics of the sounds associated with the given sound object.

During reproduction of sounds associated with the sound objects, object module 32 may enable one or more sonic characteristics of sounds associated with each of the individual sound objects to be controlled separately from the same one or more sonic characteristics of sounds associated with the other sound objects by controlling features of the audio signal from the individual sound object separate from the audio signals of the other sound objects. This control over individual sound objects during the production of the sound event associated with the sound objects may enhance the production of the sound event. For example, it may enhance the authenticity, customizability, clarity, and/or configurability of the production of the sound event. Object module 32 may control the sonic characteristics of sounds associated with individual ones of the sound objects based on input from the user via user interface 28, based on metadata associated with the sound objects and/or the sound event as a whole, and/or based on other factors (some of which are discussed below).

Rendering device module 34 obtains device metadata related to individual ones of sound rendering devices 14. The device metadata obtained by rendering device module 34 may include information associated with the suitability of individual ones of sound rendering devices 14 for reproducing sounds associated with the sound objects obtained by object module 32. For example, as used herein, the term “device metadata” may include properties of sound rendering devices 14 that enhance the production of sounds with certain sonic characteristics (e.g., the properties of sound rendering devices 14 discussed above), information related to the position of sound rendering devices 14, information related to a rotational orientation of sound rendering devices 14, and/or other information.

In some instances, at least some of the device metadata may be obtained by rendering device module 34 through manual input to playback device 20 (e.g., via user interface 28). In some instances, at least some of the device metadata may be obtained automatically by rendering device module 34. For example, rendering device module 34 may be in operative communication with individual ones of sound rendering devices 14, and may automatically communicate with sound rendering devices 14 to receive device metadata derived by, or stored on, sound rendering devices 14. In some instances, rendering device module 34 may be configured to determine at least some device metadata automatically. For instance, rendering device module 34 may be configured to automatically locate sound rendering devices 14, and to automatically determine information related to the position of individual ones of the sound rendering devices 14.

Rendering device module 34 may be configured to assign rending device metadata to individual rendering devices 14. For example, rendering device module 34 may assign a relative position to the rendering devices (e.g., left, right, middle, and/or other positions), sound object type (e.g., percussion, horns, string, etc.), and/or other rendering device metadata to individual rendering devices 14. The assignments may be based on characteristics of the rendering devices 14, input from a user (e.g., via the user interface), and/or other factors. In some implementations, rendering device module 34 may communicate with a docking station at which separate hardware modules comprising one or more rendering devices can be docked for charging. Rendering device module 34 may assign rendering device metadata to the separate hardware modules based on the docks in the docking station that hardware are docked into.

Sound rendering devices 14 may be connected along M signal paths configured to receive audio signals, and reproduce sounds based on the received signals. Path module 36 may be configured to determine the specific sound rendering devices 14 included in each of the signal paths. In some embodiments, path module 36 may further be configured to control each of the signal paths by selectively including and excluding individual sound rendering devices 14 in the signal paths. In such embodiments, path module 36 may include or exclude a given sound rendering device 14 in a signal path by powering the given sound rendering device 14 on or off (or instructing the given sound rendering device 14 to power on or off). In some embodiments, path module 36 is in operative communication with a series of switches and/or buses, and may include or exclude a given sound rendering device 14 in a signal path by controlling the switches and/or buses to switch the given sound rendering device 14 into or out of the signal path. Path module 36 may control the configuration of the signal paths automatically based on various parameters (e.g., the sonic characteristics of the sounds associated with the sound objects, the number of sound objects, the properties of sound rendering devices 14, etc.) and/or based on user input to playback device 20 (e.g., via user interface 28).

In some embodiments, each signal path may have one or more properties that enhance the production of sounds with certain sonic characteristics. For a given signal path, these properties (and/or the corresponding sonic characteristics) may be a result of the properties of the sound rendering devices 14 included in the given signal path. In certain implementations, path module 36 may obtain the one or more properties (or the corresponding sonic characteristics) of individual signal paths. For example, path module 36 may determine the one or more properties (or the corresponding sonic characteristics) of a given signal path based on an aggregation of the one or more properties of the sound rendering devices 14 included in the given signal path.

According to various embodiments, path module 36 may configure a signal path for a specific one of the sound objects obtained by object module 32. The signal path configured for the sound object may include sound rendering devices 14 that enhance the production of sounds with one or more of the sonic characteristics of the sounds associated with the sound object (e.g., as determined by object module 32, described above).

Assignment module 38 may assign individual ones of the sound objects obtained by object module 32 to the signal paths that include sound rendering devices 14. Assignment module 38 may then output audio signals obtained from the assigned sound objects by object module 32 to the assigned signal paths for production of the sounds based on the audio signals. In some embodiments, the assignment of a given sound object to one or more signal paths may be based on the audio signals associated with the given sound object, the object metadata associated with the given sound object, and/or the device metadata associated with the sound rendering devices 14 included in the assigned signal path. For example, assignment module 38 may assign the given sound object to a signal path that includes sound rendering devices 14 with one or more properties that enhance the production of sounds with one or more of the sonic characteristics of the sounds associated with the given sound object (e.g., as determined by object module 32, described above).

In some instances, assignment module 38 may assign sound objects to signal paths based on the relative locations of the sound objects (as indicated in the object metadata) and the relative locations of sound rendering devices 14 included in the signal paths. This may preserve the spatial arrangement of the sounds associated with the sound objects. The assignment of sound objects to signal paths based on the relative locations of the sound objects and sound rendering devices 14 may lead to the dynamic switching of assignments between sound objects and signal paths by assignment module 38 during production of the sound event associated with the sound objects, where object metadata indicates relative movement between sound objects during the sound event. In certain embodiments, this dynamic switching of assignments between sound objects and signal paths may be augmented (or even replaced) by dynamically switching sound rendering devices 14 into and/or out of signal paths by path module 36 to achieve apparent movement of the sound objects during the sound event.

According to various embodiments of the invention, one or more of sound rendering devices 14 may be configured to produce sounds associated with “virtual” sound objects, while one or more of sound rendering devices 14 may be configured to produce sounds associated with “physical” sound objects. As used herein, a “virtual” sound object may refer to a sound object that is produced by sound rendering devices 14 to be perceived by an observer as being generated from a location different from the physical location of the sound rendering devices 14 producing the sounds associated with the sound object. An example of this type of sound object would be a sound object reproduced via a surround-sound system (e.g., a 5.1 system, a 6.1 system, etc.). As used herein, a “physical” sound object may refer to a sound object that is produced by one or more sound rendering devices 14 such that the sound rendering devices 14 are located at the position perceived by an observer to be the source of the sound.

In some instances, assignment module 38 may assign individual sound objects to certain signal paths based on whether they should be output as virtual sound objects or physical sound objects, and whether a given signal path is configured to generate objects virtually or physically. For example, object metadata of the sound objects may indicate explicitly whether a given sound object is to be output virtually or physically. As another non-limiting example, object module 32 may determine which sound objects are to be output virtually or physically based on one or more of object metadata (e.g., one or more sonic characteristics, position, movement, etc.), resources available to playback device 20 (e.g., the number of sound rendering devices 14 capable of producing physical sound objects, processing resources, etc.), and/or other information.

Group module 40 may form one or more groups of sound objects, with each group of sound objects including two or more of the sound objects obtained by object module 32. Audio signals from the sound objects that are included within a common group may be controlled in a coordinated manner by group module 40. For example, group module 40 may control one or more of the sonic characteristics of sound dictated by the audio signals of the sound objects included within a given group of sound objects in a coordinated manner separate from the same sonic characteristics of sounds dictated by the audio signals of sound objects not included in the given group. This may include simultaneously adjusting a sonic characteristic of the sounds dictated by the audio signals of the sound objects included within the given group of sound objects without substantially impacting the same sonic characteristics of sounds dictated by the audio signals of the sound objects not included in the given group of sound objects.

In some embodiments, control of sound objects that are included within a common group may include assigning these sound objects to a common signal path, or set of signal paths, by assignment module 38 and/or path module 36. This should not be misunderstood to mean that the audio signals from the grouped sound objects are necessarily processed together within playback device 20 as a “mixed” signal that includes all of the audio signals of sound objects within the group inseparably from each other. Instead, although the audio signals of the grouped sound objects may be output over one or more common signal paths and may be controlled in a coordinated manner, discrete control over the audio signals from individual sound objects is still maintained such that audio signal(s) of a given one of the grouped sound objects may still be controlled separately by object module 32 from the other audio signals associated with the group (e.g., by modifying one or more of the sonic characteristics of the audio signals of the given object separately from the audio signals of the other sound objects in the group). Further, audio signals of individual sound objects within the group, even after inclusion in the group, may still be removed from the group by group module 40 to be processed and/or separately from the group.

In certain embodiments, group module 40 groups the sound objects based on sound content and/or metadata associated with the sound objects. For example, group module 40 may group the sound objects such that sound objects with relatively diffuse directivity patterns (which may lend themselves to output as virtual sound objects) are formed into a group, while sound objects with relatively well defined directivity patterns (which may be relatively less suited to output as virtual sound objects) may be excluded from the group. This may enable the grouped sound objects to be output to one or more signal paths that include sound productions devices that generate directionally diffuse sounds, while the sound objects with well defined directivity patterns may be output to one or more signal paths that include sound productions devices that can mimic their directivity patterns. As another example, group module 40 may group sounds that are more peripheral to a sound event together so that the reproduction of these sounds will not subsume sound production resources (e.g., sound rendering devices, processing resources on production processor 26, etc.) that are out of balance with their subjective import to the sound event. For instance, where some sound objects represent one or more ambient sound sources (e.g., traffic noise, dog barks, background conversations, etc.) and/or one or more ancillary sound sources (e.g., a set of backup vocalists, a rhythm section, etc.), these sound objects may be grouped by group module 40 for processing together in a coordinated manner, as described above.

The grouping of sound objects by group module 40 may be performed in an automated manner. The grouping may be performed (and/or manipulated) by group module 40 based on user input to playback device 20 (e.g., received via user interface 28). In some instances, the manner in which group module 40 should group obtained sound objects (at least initially) may be specified explicitly by object metadata and/or event metadata. As was mentioned above, such metadata may be included in the sound objects and/or with the sound objects by one or both of capture system 16 and/or mastering system 18.

Where group module 40 has formed a group of two or more sound objects, and the audio signals from the grouped sound objects are to be output over a common signal path, or set of signal paths, assignment module 38 may assign the audio signals from the grouped sound objects to a common signal path, or set of signal paths, based on one or both of the audio signals and/or the metadata associated with the individual sound objects in the group of sound objects. The assignment of the audio signals from the grouped sound objects 38 to the common signal path, or set of signal paths, may further be based on one or more of the properties of sound rendering devices 14 included in the common signal path, or set of signal paths.

Venue module 42 may be configured to determine information related to a venue in which a sound event is being produced by playback device 20. This information may include one or more of venue dimensions, venue surface characteristics (e.g. sound reflectivity of one or more surfaces of the venue), and/or other information related to the venue in which the sound event is being produced. Venue module 42 may compare this information with information related to the venue in which the sound objects were captured by capture system 16 (e.g., included in the event metadata). From this comparison, venue module 42 may determine adjustments to the sound objects to account for acoustical differences between the venue in which the sound objects were captured and the venue in which the sound event is being produced by playback device 20. These adjustments may be communicated from venue module 42 to object module 32 for implementation.

Preferences module 44 may manage preferences associated with playback device 20. The preferences managed by preference managed by preference module 44 may include preferences associated with an individual user, a group of users, or the “preferences” may refer to settings configured for any use of playback device 20 (e.g., configured by a technician installing some or all of the components of playback device 20). The preferences may dictate the manner in which other modules provided within playback device 20 process and/or output obtained sound objects. In some instances, the preferences may dictate defaults for processing and/or output that can be further adjusted by a user (e.g., via user interface 28).

For example, with respect to path module 36, preference module 44 may manage one or more preferences related to configurations of one or more signal paths managed by path module 36. In some embodiments in which path module 36 is configured to selectively include or exclude sound rendering devices 14 within the signal paths, preference module 44 may manage a preference for selectively including or excluding certain ones of sound rendering devices 14 within one or more preferred signal path configurations. For instance, a user may enter a preference to preference module 44 for one or more preferred signal paths that are to be automatically configured by path module 36 while user is controlling playback device 20. This preference may be entered to preference module 44 by the user to be contingent upon some other event (e.g., obtaining one or more sound objects with a certain sonic characteristic, a certain sound object type, etc.) such that if the event (or events) associated with the preference are detected, preference module 44 causes path module 36 to configure the previously specified signal path(s).

In some embodiments, preference module 44 may store a set of templates for signal paths that can be configured by path module 36 by selectively including or excluding sound rendering devices 14 within a signal path. A given template may be selected by a user (e.g., via user interface 28) to initiate configuration of the signal path that corresponds to the given template. These templates may include templates that are pre-programmed to production processor 26, downloaded from an external source (e.g., the Internet, a removable storage media, etc.), obtained with the sound objects associated with a given sound event, or obtained from some other source. In some instances, the templates may be adjusted by a user, or even created completely by the user. The templates may enable a user to quickly configure a “custom” signal path without having to manually select individual sound rendering devices 14 for inclusion or exclusion in the signal path.

According to various embodiments, preference module 44 may automatically track user interaction with path module 36, and may suggest preferences to the user. For example, preference module 44 may track the signal paths configured by the user over time, and may identify a signal path configuration that is repeatedly created by the user. Preference module 44 may then present this signal path configuration to the user with the suggestion that the configuration be saved as a template. Upon approval from the user, preference module 44 may then save the signal path configuration as a template. As another non-limiting example, preference module may identify a modification that the user repeatedly makes to the configuration of a signal path that corresponds to a given template. Preference module 44 may present an option to the user to modify the given template in accordance with the modification, which may relieve the user from having to make this modification in the future. Similarly, preference module 44 may present an option to the user to create a new template that corresponds to the given template with the exception of the modification that is frequently made by the user. This may relieve the user of having to make the modification in the future, while still enabling the user to access the given template in its unaltered form.

With respect to assignment module 38, preference module 44 may manage one or more preferences related to the manner in which sound objects are assigned to signal paths. This may include preferences that dictate that sound objects with certain properties are assigned to predetermined signal paths, or predetermined types of signal paths. The properties of a sound object may include one or more sonic characteristics of the sound object, one or more sonic characteristics of the sounds associated with a sound object, one or more properties of sound content associated with the sound object, a position of the sound object, a rotational orientation of the sound object, movement of the sound object, an object type of the sound object (e.g., a type of musical instrument, a brand and type of musical instrument, a type and style of musical instrument, etc.), an object identity of the sound object (e.g., a name of a singer), an identity of a person involved in the production of sounds associated with the sound object (e.g., a name of a drummer playing a drum kit), an identity of a part being filled by the sound object in a sound event (e.g., rhythm guitar, tenor vocalist, etc.), and/or other properties. In some instances, the preferences managed by preference module 44 with respect to the assignment of sound objects to signal paths may define and/or influence default assignments of sound objects to signal paths that can then be adjusted by a user (e.g., via user interface 28).

For example, preference module 44 may manage a preference that sound objects with a certain object type (e.g., all “guitar” sound objects) be assigned to signal paths including one or more sound rendering devices 14 with one or more properties defined by the preference (e.g., one or more sources that mimic the sonic characteristics of the certain object type). The one or more properties may include one or more properties of sound rendering devices 14 that enhance the production of sounds associated with sound objects of the certain object type. Based on this preference, assignment module 44 may automatically assign obtained sound objects of the certain type to signal paths in accordance with the preference.

In some instances, the preferences managed by preference module 44 may be based on more than one parameter (e.g., the example of the object type preference above is an example of a preference based on single parameter, namely, object type). For example, a given preference may dictate and/or influence assignment of a sound object to one or more signal paths based on a plurality of properties of the sound object. In some instances, a given preference may dictate and/or influence assignment of a set of sound objects to a set of signal paths based on one or more properties of each of the individual sound objects included in the set of sound objects. For instance, a given preference may dictate that for a sound event that includes sound objects corresponding to a traditional jazz trio (e.g. drums, bass, and soloist), the sound objects are to be assigned to their role within the trio. In other words, where the sound objects designate a drum kit, a bass, and a soloing instrument (e.g., saxophone, clarinet, piano, guitar, etc.), a preference managed by preference module 44 may dictate and/or influence the assignment of these sound objects to signal paths designated in the preference for the rhythm objects (e.g., the drum kit and bass) and the soloing instrument. In some implementations, the preference may further require that event metadata associated with the sound objects indicate that this is a jazz trio, and not some other type of performance (e.g., rock band), or a part of an event that includes additional sound objects (e.g., the trio backs a vocalist).

According to various embodiments, one or more of the preferences managed by preference module 44 may be conceptualized as templates that assign sound objects with certain properties to signal paths that include sound rendering devices 14 with certain properties. In some instances, a template may correspond to an event type. For example, an event type may include a concert, a movie, a television show, a sporting event, a video game, and/or other event types. Event types, in some implementations, may be even more specific. For example, an event type may include a rock concert, a jazz concert, a symphony concert, an opera, an action movie, a romantic movie, a comedic television show, a reality television show, a basketball game, a bull fight, a world cup soccer match, a Halo 3 game, a Grand Theft Auto game, and/or other event types. An event type of a sound event may be determined by preference module 44 based on the sound objects associated with the sound event, based on event metadata captured by capture system 16 (and/or included with the sound objects at mastering system 18), based on user input to playback device 20 (e.g., via user interface 28) and/or based on other information related to the sound event.

A preference that corresponds to a given event type may dictate and/or influence the assignment of sound objects generally associated with the given event type to signal paths with configurations of sound rendering devices 14 that lend themselves to the production of sounds associated with sound generally associated with the given event type. For example, if the given event type is a popular music concert, the preference may dictate and/or influence the assignment of a sound object associated with a lead performer (e.g., a lead singer) to a signal path with one or more sound rendering devices 14 that have one or more properties that enhance production of sounds generally associated with a lead performer. For example, such a signal path may include one or more sound rendering devices 14 located at a centralized position, one or more sound rendering devices 14 with acoustic properties that enhance production of sounds generally associated with a lead performer, and/or other sound rendering devices. Similarly, the same preference may dictate and/or influence the assignment of individual ones of the other sound objects associated with the concert to signal paths that have one or more properties that enhance production of the sounds generally associated with other individual sound objects typically included in such a concert (e.g., typical instruments, backup vocalists, crowd noises, etc.).

In some instances, a preference managed by preference module 44 may be event and/or sound object specific. For example, the preference may include a template for assigning the sound objects associated with a given event to signal paths. The preference may be specifically designed for the specific event. Such a preference may be included, for example, in event metadata associated with the sound event, or may be previously stored at playback device 20. In some instances, such a, preference may be created by the user (e.g., via user interface 28). For example, the preference may be based on a previous assignment of the sound objects associated with the given sound event to signal paths that is specified by the user to be saved as a preference for production of the given sound event in the future.

In some embodiments, preference module 44 may present the user (e.g., via user interface 28) with a plurality of preferences (e.g., a plurality of templates) for dictating and/or influencing the assignment of sound objects to signal paths for a sound event to enable the user to select a preference to be applied to the sound event. In some such embodiments, preference module 44 may preliminarily apply one of the preferences (e.g., based on previous use, etc.), and may request approval from the user. If the user does not approve, then the user may select an alternative preference to be applied from the plurality of preferences.

According to various embodiments, preference module 44 may manage the preferences related to assignment module 38 such that existing preferences may be adjusted and/or new preferences may be created automatically by tracking adjustments made to assignments of sound objects to signal paths by the user. As a non-limiting example of this functionality, preference module 44 may observe that the user routinely assigns sound objects of a certain type to a particular signal path. Based on this observation, preference module 44 may create a preference that dictates that sound objects of the certain type be assigned by assignment module to the particular signal path. In some instances, preference module 44 may request authorization from the user before creating the preference.

With respect to group module 40, preference module 44 may manage preferences related to the grouping of sound objects by groups module 40. This may include preferences that dictate that sound objects with one or more similar properties are grouped together. Such preferences may specify the one or more properties upon which the grouping should be base, the correlation required between the specified one or more properties to warrant grouping, and/or other aspects of the grouping of sound objects. The properties of a sound object may include one or more sonic characteristics of the sound object, one or more sonic characteristics of the sounds associated with a sound object, one or more properties of sound content associated with the sound object, a position of the sound object, a rotational orientation of the sound object, movement of the sound object, an object type of the sound object (e.g., a type of musical instrument, a brand and type of musical instrument, a type and style of musical instrument, etc.), an object identity of the sound object (e.g., a name of a singer), an identity of a person involved in the production of sounds associated with the sound object (e.g., a name of a drummer playing a drum kit), an identity of a part being filled by the sound object in a sound event (e.g., rhythm guitar, tenor vocalist, etc.), and/or other properties.

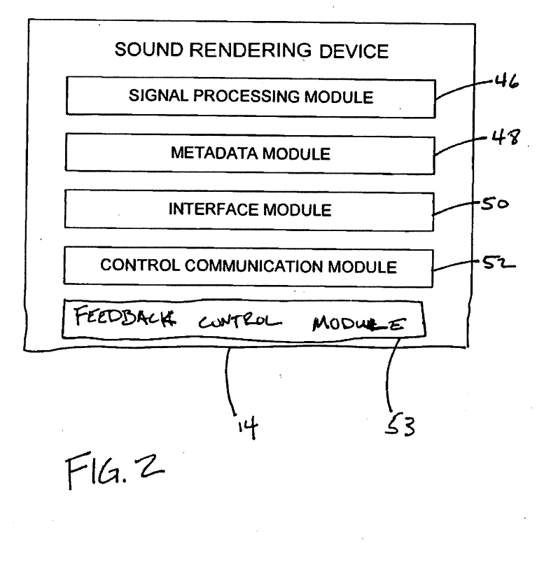

FIG. 2 illustrates a sound rendering device 14, in accordance with one or more embodiments of the invention. Certain aspects and/or components of sound rendering device 14 are discussed below with respect to operation within system 10 (illustrated in FIG. 1 and described above). However, it should be appreciated that this is not intended to be limiting, and that sound rendering device 14 may be implemented in a variety of alternate systems to process signals to generate sounds. Sound rendering device 14 illustrated in FIG. 2 may include one or more speaker elements, one or more amplifier elements, and/or some combination thereof.

As is illustrated in FIG. 2, sound rendering device 14 may include one or more of a sound signal processing module 46, a metadata module 48, a control communication module 50, a metadata module 52, a feedback control module 53, and/or other modules. Modules of sound rendering device 14 (e.g., modules 46, 48, 50, 52, and 53) may be implemented in software; hardware; firmware; some combination of software, hardware, and/or firmware; and/or otherwise implemented. It should be appreciated that although modules 46, 48, 50, 52, and 53 are illustrated in FIG. 1 as being co-located within a single processing unit, in some implementations sound rendering device 14 may have a distributed architecture such that, one or more of modules 46, 48, 50, 52, and/or 53 may be located remotely from the other modules.

Sound signal processing module 46 may process signals to facilitate the production of sounds based on the signals. For example, in instances in which sound rendering device 14 includes an amplifier, sound signal processing module 46 may, among other things, amplify a signal. As another non-limiting example, in instances in which sound rendering device 14 includes a speaker, sound signal processing module 46 may, among other things, generate a sound wave from a received signal.

Metadata module 48 may store and/or manage device metadata associated with sound rendering device 14. The device metadata may include information related to sound rendering device 14 such as, for example, information associated with the suitability of sound rendering device 14 for producing sounds with various sonic characteristics. For example, such information may include properties of sound rendering device 14 that enhance the production of sounds with certain sonic characteristics, information related to the position of sound rendering device 14, information related to a rotational orientation of sound rendering device 14, a brand name of sound rendering device 14, a model name and/or number of sound rendering device, and/or other information. In some instances, the device metadata may include information provided to metadata module 48 at or near the time of manufacture of sound rendering device 14, information provided to metadata module 48 at or near the time of installation of sound rendering device 14 in a venue as a component in playback device 20, and/or at other times. In certain embodiments, at least some of the device metadata stored and/or managed by metadata module 48 may be entered and/or adjusted by a user. In some embodiments, at least some of the device metadata stored and/or managed by metadata module 48 may be provided to metadata module 48 by a manufacturer and/or technician. Some or all of the device metadata provided to metadata module 48 by a manufacturer and/or technician may be stored and/or managed by metadata module 48 such that it cannot be adjusted by a user.

Interface module 50 may include managing communication of information between a user and sound rendering device module 14. Such communication may include the communication of device metadata to a user and/or the communication of device metadata (and/or adjustments to be made to the device metadata) to sound rendering device 14. In some embodiments, interface module 50 may manage communication between the user and sound rendering device 14 accomplished via a user interface. This user interface may include a user interface located locally on sound rendering device 14, or a user interface located remotely from sound rendering device 14 (e.g., user interface 28).

Control communication module 52 may manage communication between sound rendering device 14 and one or more other components of playback device 20. For example, control communication module 52 may receive information from and/or transmit information to production processor 26. The information communicated by control communication module 52 may include the communication of device metadata from sound rendering device 14 to production processor 26 (e.g., to rendering device module 34). This communication may enable production processor 26 to make determinations with respect to which sound objects will be assigned to signal paths that include sound rendering device 14 illustrated in FIG. 2.

Communication between playback device 20 and control communication module 52 may be implemented via communication media different than the communication of audio signals from playback device 20 to control communication module 52. For example, sound rendering device 14 may be a “wireless” device configured to receive audio signals from playback device 20 wirelessly. Despite this wireless capability, some or all of the control communication that takes place between control communication module 52 and playback device may be implemented in wired communication media, and/or in wireless communication media different than the wireless media used to communicate audio signals.

For instance, playback device 20 may include a docking station at which sound rendering device 14 may be docked. The docking station may include docks that provide an operative link between sound rendering device 14 and playback device 20. Through the docking station the rendering device 14 may obtain power to recharge a rechargeable power supply carried on sound rendering device 14. The docking station may provide an operative link between control communication module 52 and playback device 20. Over this operative link, control communication module 52 may provide device metadata to playback device 20, the wireless connection between sound rendering device 14 and playback device 20 may be initiated and/or configured, and/or other communication between sound rendering device 14 and playback device 20 may be achieved.

The communication between sound rendering device 14 and playback device 20 achieved via the docking station may include device metadata assigned to sound rendering device 14 by rendering device module 34. The communication from playback device 20 to sound rendering device 14 via the docking station may include one or more signal path assignments made by path module 36. The communication between playback device 20 and sound rendering device 14 via the docking station may include assignments of one or more sound objects and/or groups of sound objects (and the associated audio signals) to sound rendering device 14. Other communication achieved over the docking station between playback device 20 and sound rendering device 14 are contemplated.

Feedback control module 53 may be configured to capture and/or process feedback information that can be provided to one or more other components of playback device 20 (e.g., production processor 26) to enhance the production of sounds by sound rendering device 14. In some embodiments, the feedback information may include sound information actually being produced by sound rendering device 14 (e.g., recorded by a transducer on sound rendering device 14). The sound information may then be provided to production processor 26 via feedback control module 53 to enable production processor 26 to compare sound actually being generated by sound rendering device 14 with the sound intended for sound rendering device 14, and to adjust control of sound rendering device 14 in a feedback manner. In some embodiments, feedback control module 53 implements some or all of the feedback functionality locally at sound reproduction device 14, thereby reducing processing load on production processor 26. For example, feedback control module 53 may process the sound information generated by sound rendering device and may analyze the sound information to ensure accuracy with respect to sounds that should be produced, adjust performance of sound rendering device 14 on a feedback basis, diagnose maintenance and/or other system hardware issues, and/or provide other functionality based on the captured sound information.

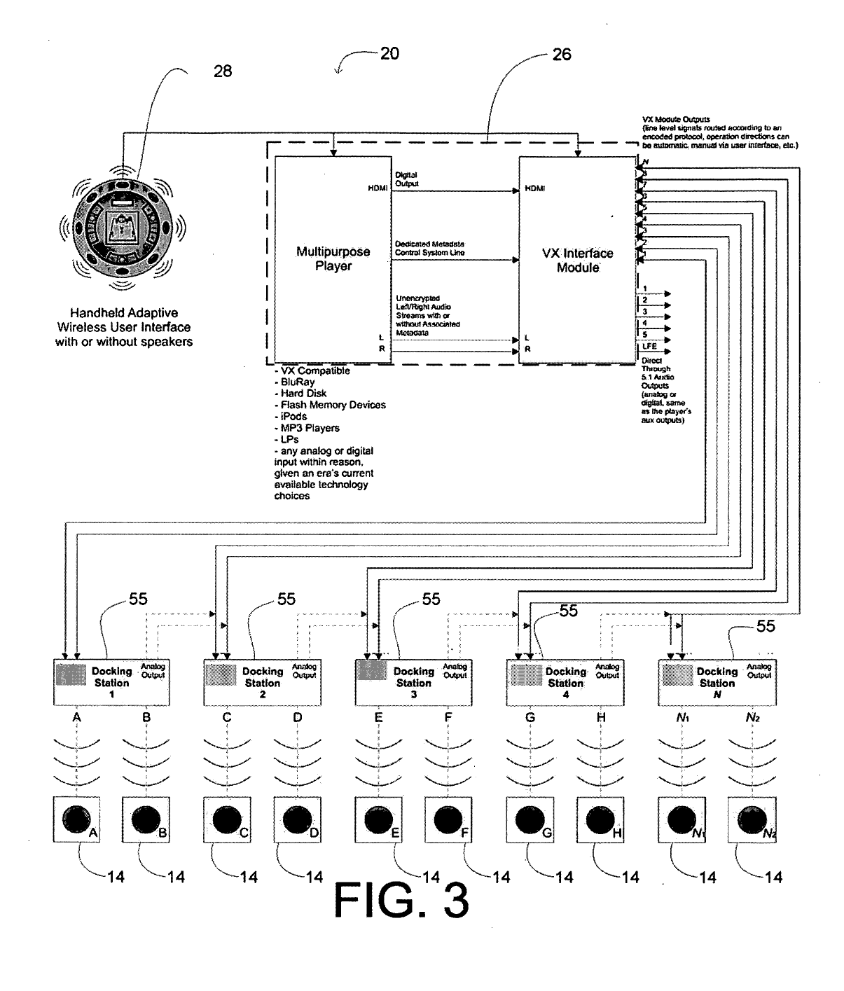

FIG. 3 illustrates an embodiment in which playback device 20 may be configured to communicate with a plurality of docking stations 55. Docking stations 55 may be configured to include some or all of the features discussed above with respect to the communication of sound rendering devices 14 with playback device 20 through a docking station. In the embodiment shown in FIG. 3, the sound rendering devices 14 may communicate wirelessly with playback device 20, or the sound rendering devices may communicate wirelessly.

A given docking station 55 may be operatively linked with playback device 20. Via this operative link, the given docking station 55 may transmit and/or receive information and/or power from playback device 20. The information may include audio signals, metadata (e.g., device metadata, object metadata, venue metadata, event metadata, or other metadata), information related to signals path(s), information related to object groups, device feedback information, and/or other information.

A given docking station 55 may include one or more docks at which a sound rendering device 14 can be docked. The given docking station 55 may be configured to transmit and/or receive information and/or power to or from the sound rendering device 14 docked therein. The information may include, for example, audio signals, metadata (e.g., device metadata, object metadata, venue metadata, event metadata, or other metadata), information related to signals path(s), information related to object groups, device feedback information, and/or other information.

While a sound rendering device 14 is docked at a dock of a given docking station 55, the docking station 55 may be configured to configure and/or establish a wireless communication link between the docking station 55 and the docked sound rendering device 14. This wireless communication link may enable the docking station 55 to communicate information with the docked sound rendering device 14 once the sound rendering device is removed from the dock. The information communicated over the wireless link may include one or more of audio signals, metadata (e.g., device metadata, object metadata, venue metadata, event metadata, or other metadata), information related to signals path(s), information related to object groups, device feedback information, and/or other information.

An exemplary implementation of the communications between playback device 20, docking stations 55, and sound rendering devices 14 follow. It will be appreciated that this example is not intended to be limiting with respect to the manner in which the playback device 20, docking stations 55, and sound rendering device 14 can be used. In the exemplary implementation, a given sound rendering device 14 may be selectively docked at the dock of one of docking stations 55. The dock at which the given sound rendering device 14 is docked may be selected by the user, and/or may be dictated by the electronic and/or physical specifications of the given sound rendering device 14 and the docks. For instance, the given sound rendering device 14 may be compatible with a plurality of different docks, or may be compatible with only one dock.

As the given sound rendering device 14 is docked, the docking station 55 providing the dock may establish a communication link with the given sound rendering device 14 through the dock. Over this communication link, information may be exchanged by the docking station 55 and the sound rendering device 14.

The information communicated between the docking station 55 and the given sound rendering device 14 may enable the docking station 55 to configure and/or establish a wireless communication link with the given sound rendering device 14. The information communicated between the docking station 55 and the given sound rendering device 14 may include device metadata provided from the sound rendering device 14 to the docking station 55. Upon receiving the device metadata, docking station 55 may transmit the device metadata corresponding to the given sound rendering device 14 to playback device 20.

Playback device 20 may implement the received device metadata to identify one or more features, parameters, and/or sound characteristics of the given sound rendering device 14. The playback device 20 may provide some or all of the received device metadata and/or the identified one or more features, parameters and/or sound characteristics of the given sound rendering device 14 to a user via user interface 28.

Playback device 20 may assign the given sound rendering device 14 to a signal path, and/or may assign an object or group of objects to the assigned signal path. The playback device 20 may make one or both of these assignments automatically and/or in accordance with a user selection. The assignment(s), whether automatic or based on user selection, may be impacted by the device metadata received from the docking station 55 and/or the identified one or more features, parameters, and/or sound characteristics identified therefrom by playback device 20.

Playback device 20 may provide audio signals to the docking station 55. The audio signals may correspond to sound objects and/or groups of sound objects that are to assigned to a signal path including the given sound rendering device 14. The docking station 55 may transmit the audio signals to the given sound rendering device 14. This may be accomplished, for example, over a wireless communication link between the docking station 55 and the given sound rendering device 14 (e.g., the link established and/or configured while the given sound rendering devices was docked at the docking station 55).

After the given sound rendering device 14 has been removed from the dock of the docking station 55. The docking station 55 may continue to acquire information related to the given sound rendering device 14. This information may include information transmitted to the docking station 55 by the given sound rendering device 14 wirelessly, information detected by the docking station 55, and/or other information. The information may include, for example, position and/or motion information, feedback information, and/or other information. The docking station 55 may transmit the received information to playback device 20. The playback device 20 may convey some or all of the information to a user via user interface 28. The playback device 20 may implement the information in assigning the given sound rendering device 14 to a signal path and/or in assigning one or more sound objects or groups of sound objects to the signal path including the given sound rendering device 14. The assignment of the given sound rendering device 14 to a signal path and/or the assignment of one or more sound objects or groups of sound objects to the signal path including the given sound rendering device 14 may be dynamic and/or adaptive.

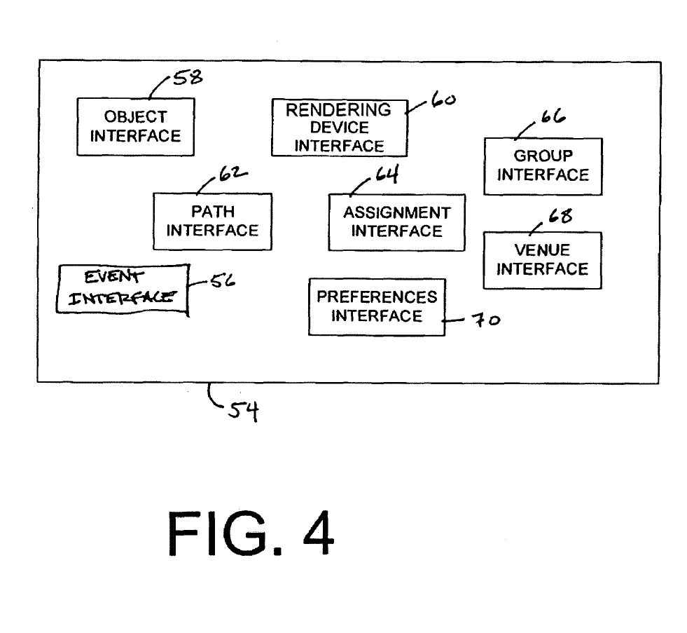

FIG. 4 illustrates a user interface 54, according to one or more embodiments of the invention. User interface 54 may comprise a Graphical User Interface (“GUI”), or some other user interface, that is presented to a user via an electronic display. In some instances, user interface 54 may make up at least part of user interface 28, illustrated in FIG. 1 and described above. Although some of the functionality provided by user interface 54 is discussed below with respect to components of system 10 illustrated in FIG. 1, it should be appreciated that this is not intended to be limiting. User interface 54 may be implemented in a variety of different systems that involve the production of sound events in order to enhance the production of a given sound event.

User interface 54 may enable a user to separately interact with the production of sounds associated with individual sound objects included within a sound event. This may enhance the control of the user to customize the production of the sound event. The enhancement of the user's control over the production of the sound event may be implemented by a user to enhance the authenticity of the sound event, to purposely alter the sound event during production, to adjust production of the sound event to account for one or more aspects of the production venue, and/or for other purposes. In some embodiments, user interface 54 may include one or more of an event interface 56, an object interface 58, a rendering device interface 60, a path interface 62, an assignment interface 64, a group interface 66, a venue interface 68, a preferences interface 70 and/or other interfaces. Although user interface 54 is illustrated in FIG. 4 as including a single view that includes each of interfaces 56, 58, 60, 62, 64, 66, 68, and 70, in some instances user interface 54 may include a plurality of views wherein a given view may not include all of the component interfaces (e.g., 56, 58, 60, 62, 64, 66, 68, and 70) included in user interface 54.

Event interface 56 may graphically represent information generally related to a sound event associated with a set of obtained sound objects. As used herein, the term “graphically represent” may refer to a representation of information to a user that can be presented to the user on a graphic display. This representation may include information presented in an alphanumeric form, a form that implements non-alphanumeric symbols, colors, sizes of objects or symbols, spatial relationships between objects or symbols, and/or other forms that represent information in a manner that can be presented to a user on a graphic display.

The information represented by event interface 56 may include information referred to above as event metadata. Event metadata may include, for example, an event title (e.g., a song title, a movie title, an episode title, a game title, a concert identification, etc.), an event date and/or time, an identification of a configuration of the sound objects of the sound event (e.g. a band, an orchestra, etc.), and/or other information generally related to the sound event. Event interface 56 may be configured such that event metadata may be adjustable by a user via event interface 56. For instance, the user may alter, or enter for the first time, an event title, an event data and/or time, an identification of a configuration of the sound objects of the sound event, and/or other event metadata.

The information conveyed by event interface 56 may include parameters for the production of the sound event that generally apply to the sound objects in the sound event. For example, these parameters may include one or more sonic characteristics of the sound event as a whole (e.g., a global volume level, global equalizer settings (e.g., tone settings, etc.), global playback speed settings, global distortion settings, etc.), and/or other parameters. Event interface 56 may enable a user to adjust one or more of these parameters (e.g., adjust the global volume setting to turn the volume “up” or “down”) through manipulation of event interface 56. Manipulation of event interface 56 may include entering information to and/or selecting or adjusting information in event interface 56 via an input device (e.g., a keyboard, a keypad, a mouse, a joystick, a trackball, a microphone, a touchpad, a touch screen, etc.).

Object interface 58 may graphically represent obtained sound objects separately from each other. Object interface 58 may include an object metadata representation that represents object metadata associated with individual ones of the sound objects (e.g., object metadata managed by object module 32). The object metadata may include object metadata that has been obtained with the sound objects and/or object metadata that has been associated with the sound objects by the user via object interface 58. Further, object interface 58 may enable the user to adjust the object metadata associated with a given sound object through manipulation of object interface 58. Adjustments and/or entry of object metadata via object interface 58 may be permanently and/or temporarily (e.g., for a single production of an event) reflected in the object metadata managed by object module 32.

Object interface 58 may represent information related to one or more sonic characteristics of the audio signals associated with the sound objects on a sound object by sound object basis. While some information related to the one or more sonic characteristics of a given sound object may be represented in the metadata representation corresponding to the given sound object, the one or more sonic characteristics of the given sound object may further include parameters of the production of the sounds associated with the given sound object. These parameters may include, for example, a volume level, one or more equalizer settings for the sound object that impact the tone of the sounds associated with the given sound object, and/or other parameters of the production of the sounds associated with the given sound object. Object interface 58 may enable the user to adjust one or more of the parameters of the production of the sounds associated with the given sound object by manipulating object interface 58.

Rendering device interface 60 may graphically represent individual ones of sound rendering devices 14. For example, rendering device interface 60 may include a device metadata representation that represents, on a device by device basis, device metadata (e.g., device metadata managed by rendering device module 34). Rendering device interface 60 may enable the user to adjust and/or enter device metadata for specific ones of sound rendering devices 14 by manipulating rendering device interface 60. The adjustments to device metadata made by the user via rendering device interface 60 may be permanently and/or temporarily (e.g., for a single production of the sound event) in the device metadata managed by rendering device module 34.

Path interface 62 may graphically represent a plurality of signal paths that each include a set of one or more of sound rendering devices 14 (e.g., the signal paths managed by path module 36). The representation of a given signal path provided by path interface 62 may include one or more of a representation of the sound rendering devices 14 included in the signal path, a representation of one or more of the properties of the given signal path that enhance the production of sounds with certain sonic characteristics (e.g., as determined by path module 36), and/or other information related to the given signal path.

In some embodiments, path interface 62 may enable the user to configure individual signal paths, and/or adjust existing signal path configurations, by manipulating path interface 62 to select individual sound rendering devices 14 for inclusion in and/or exclusion from a given signal path. Upon selection by the user of a given sound rendering device 14 for inclusion in and/or exclusion from a corresponding signal path, path module 36 may adjust the signal path accordingly, as was discussed above. In some instances, the user manipulate path interface 62 to select one or more sonic characteristics of sounds to be output over a given signal path and/or may select one or more properties for the signal path as a whole. This selection may be communicated to path module 36, which may then automatically configure the given signal path to include one or more sound rendering devices 14 to provide the selected one or more properties and/or to enhance the production of sounds with the selected one or more sonic characteristics.

Assignment interface 64 may graphically represent the assignment of individual ones of the sound objects associated with an event to individual ones of a plurality of signal paths for output of the audio signal(s) from the individual sound objects the assigned signal paths. As was described above, these assignments of sound objects to signal paths may be made by assignment module 64 in an at least partially automated manner (e.g., based on object metadata, device metadata, event metadata, sound content, etc.). In some embodiments, assignment interface 64 may be selectively manipulated by the user to make and/or adjust assignments of sound objects to signal paths.

Group interface 66 may graphically represent one or more groups of sound objects (as grouped by group module 40). Group interface 66 may enable a user to create and/or adjust audio signals from a group of sound objects by manipulating group interface 66 to select specific sound objects for inclusion in and/or exclusion from a given group. In some instances, the user may adjust one or more sonic characteristics of the audio signals of the sound objects in a given group in a coordinated manner, separately from audio signals of sound objects not in the given group, by manipulating group interface 66. This may include adjusting object metadata associated with one or more of the sound objects included in the given group in a coordinated manner and/or adjusting one or more parameters of the production of sounds associated with the sound objects in the given group in a coordinated manner.

Venue interface 68 may graphically represent information related to a venue in which a sound event is being produced. This information may include one or more of venue dimensions, venue surface characteristics (e.g., sound reflectivity of one or more surfaces of the venue), and/or other information related to the venue in which the sound event is being produced. Venue interface 68 may be configured such that a user can manipulate interface 68 to enter and/or adjust the information related to the venue.

Preferences interface 70 may graphically represent information related to one or more preferences of a user. For example, preference module 44 has been described above as managing various preferences of a user with respect to sound objects, production devices, signal paths, sound object to signal path assignments, and the grouping of sound objects. Preference interface 70 may provide representations of these preferences that enable the user to interact with the preferences. This interaction may include adjusting preferences, creating preferences, selecting preferences to be applied, approving preferences that are created and/or suggested automatically based on tracking interaction by the user with playback device 20, and/or other interaction with the preferences.

As was mentioned briefly above, in some embodiments, user interface 54 may include a plurality of views. Within a given view, a user may interact with user interface 54 to enter another view to interact with information that may not be displayed in the current view (or may be displayed differently). For example, user interface 54 illustrated in FIG. 4 may enable a user to select a view related more particularly to one or more of the component interfaces 58, 60, 62, 64, 66, 68, and/or 70. In some instances, the user may be enabled by user interface 54 to configure, or even create, views that present, and/or enable interaction with, information in a manner preferred by the user.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A user interface configured to control a system that drives a plurality of sound rendering devices to produce a sound event associated with a set of sound objects, the user interface comprising:
a sound object interface that graphically represents N discrete sound objects, N being an integer greater than 1, wherein a given sound object corresponds to a sound source that generates sound during a sound event, and wherein the sound object interface represents individual ones of the sound objects separately from the other sound objects;
a metadata representation that graphically represents metadata associated with the sound objects; and
an assignment interface that graphically represents the assignment of the N sound objects to M signal paths for output, wherein each signal path comprises a set of sound rendering devices, wherein the sound rendering devices of a given signal path output only sound content associated with individual sound objects assigned to the given signal path, and wherein the assignment of individual ones of the sound objects to individual ones of the signal paths is configurable by a user through manipulation of the assignment interface.

2. The user interface of claim 1, further comprising a rendering device interface that graphically represents metadata associated with the sound rendering devices.

3. The user interface of claim 1, wherein the rendering device interface enables the user to manipulate the metadata associated with the sound rendering devices.

4. The user interface of claim 2, wherein each of the sound rendering devices possesses one or more properties that enhance production of sounds with certain sonic characteristics, and wherein the metadata represented by the rendering device interface comprises information related to the one or more properties of individual ones of the sound rendering devices that enhance production of sounds with certain sonic characteristics.

5. The user interface of claim 4, further comprising a path interface that identifies individual sound rendering devices as being included in individual ones of the M signal paths.

6. The user interface of claim 2, wherein the metadata represented by the rendering device interface comprises information related to the relative positions of individual ones of the sound rendering devices.

7. The user interface of claim 2, further comprising a path interface that identifies individual sound rendering devices as being included in individual ones of the M signal paths.

8. The user interface of claim 1, further comprising a path interface that identifies individual sound rendering devices as being included in individual ones of the M signal paths.

9. A user interface configured to control a system that drives a plurality of sound rendering devices to produce a sound event associated with a set of sound objects, the user interface comprising:
a sound object interface that graphically represents N discrete sound objects, N being an integer greater than 1, wherein a given sound object corresponds to a sound source that generates sound during a sound event, and wherein the sound object interface represents individual ones of the sound objects separately from the other sound objects;
a path interface that graphically represents M signal paths, wherein each signal path comprises a set of sound rendering devices; and
an assignment interface that graphically represents the assignment of the N sound objects to the M signal paths for output, wherein the sound rendering devices of a given signal path output only sound content associated with individual sound objects assigned to the given signal path.

10. The user interface of claim 9, wherein the assignment of individual ones of the sound objects to individual ones of the signal paths is configurable by a user through manipulation of the assignment interface.

11. The user interface of claim 9, wherein the path interface represents which of the sound rendering devices are included in individual ones of the signal paths.

12. The user interface of claim 9, further comprising a production device metadata representation that graphically represents metadata associated with the sound rendering devices.

13. The user interface of claim 12, wherein the production device metadata representation represents metadata associated with individual ones of the sound rendering devices.

14. The user interface of claim 13, wherein the production device metadata enables a user to manipulate the metadata associated with individual ones of the sound rendering devices.

15. The user interface of claim 13, wherein each of the sound rendering devices possesses one or more properties that enhance production of sounds with certain sonic characteristics, and wherein the metadata associated with a given sound rendering device is related to the one or more properties of the given sound rendering device that enhance production of sounds with the certain sound characteristics.

16. A user interface configured to control a system that drives a plurality of sound rendering devices to produce a sound event associated with a set of sound objects, the user interface comprising:
a sound object interface that graphically represents a plurality of discrete sound objects, wherein a given sound object corresponds to a sound source that generates sound during a sound event, wherein the sound object interface represents individual ones of the sound objects separately from the other sound objects, and wherein the sound object interface enables a user to adjust one or more sonic characteristics of the production of sounds associated with individual ones of the sound objects separately from the same one or more sonic characteristics of the production of sounds associated with the other sound objects; and
a group interface that graphically represents one or more groups of sound objects, wherein a given group of sound objects includes at least two of the N sound objects, and wherein the group interface enables the user to adjust one or more sonic characteristics of the production of sounds associated with the sound objects included in the given group of sound objects in a coordinated manner separately from the same one or more sonic characteristics of the production of sounds associated with the other sound objects.

17. The user interface of claim 16, wherein the group interface enables the user to manipulate the grouping of the sound objects into the one or more groups by specifying sound objects for inclusion in or exclusion from a specified one of the one or more groups.

18. The user interface of claim 16, wherein controlling one or more of the sonic characteristics of the production of sounds associated with the sound objects included in the given group in a coordinated manner comprises simultaneously adjusting a sonic characteristic of the production of the sounds associated with the sound objects included in the given group without substantially impacting the same sonic characteristic of the production of the sounds associated with sound objects not included in the given group.

19. The user interface of claim 16, further comprising an object metadata representation that graphically represents metadata associated with the sound objects.

20. The user interface of claim 16, further comprising a group metadata representation that graphically represents metadata associated with the one or more groups of sound objects.
